(19) United States
(12) Patent Application Publication
(10) Pub. No.: US 2003/0128103 A1
(43) Pub. Date: Jul. 10, 2003

(54) Multi-position display for vehicle

(76) Inventors: Robert C. Fitzpatrick, Holland, MI (US); David B. Busch, Holland, MI (US); David J. McCarthy, Holland, MI (US)

Correspondence Address: FOLEY & LARDNER, 777 EAST WISCONSIN AVENUE, SUITE 3800, MILWAUKEE, WI, 53202-5308, US

(21) Appl. No.: 10/041,180

(22) Filed: Jan. 4, 2002

(51) Int. Cl. B60Q 1/00

(52) U.S. Cl. 340/425.5; 340/438; 340/995.1; 345/1.3; 345/31

(57) ABSTRACT

A multi-position display for a vehicle comprises a housing movable between first and second positions and a display surface having first and second portions. The first portion of the display surface is viewable by a vehicle occupant when the housing is in the first position and the second portion of the display is viewable by the vehicle occupant when the housing is in the second position

### BACKGROUND OF THE DISCLOSURE

In the field of automotive electronics, automobile manufacturers have introduced numerous information systems to provide data to the driver and other vehicle occupants. This data can include various types of vehicle data, such as, speed, thermal comfort data, navigation data, audio or visual entertainment, and many other types of data. Some vehicle data is useful to assess the operation of the vehicle, such as fuel level, and other vehicle data serves to inform or entertain the vehicle occupants, such as MP3 players and navigation systems. Such data is displayed to the vehicle occupants by mounting a display in the vehicle interior.

One drawback of existing displays is that the vehicle occupants are overwhelmed with the quantity of data. As a result, less data is displayed than might be useful or needed by the vehicle occupants.

Another drawback of existing displays is that, as back-lit displays, such as liquid crystal displays, get larger, the amount of light provided to the vehicle occupants increases, which can be undesirable when driving at night or under other low light conditions. One attempted solution to this problem is to include a “night mode” on instrument cluster displays wherein displays which are less frequently used are turned off in response to user actuation of a switch. However, this solution also reduces the amount of data available to the vehicle occupants.

Accordingly, there is a need for a multi-position or multi-mode display for a vehicle. Further, there is a need for a display for a vehicle which reduces the amount of backlighting that the vehicle occupants are exposed to. Further still, there is a need for a display which can provide a variety of data without overwhelming vehicle occupants. Further yet, there is a need for a multi-position or multi-mode display for use on an instrument panel of a vehicle. The teachings hereinbelow extend to those embodiments which fall within the scope of the appended claims, regardless of whether they accomplish one or more of the above-mentioned needs.

### SUMMARY OF EXEMPLARY EMBODIMENTS

According to one exemplary embodiment, a multi-position display for a vehicle comprises a housing movable between first and second positions and a display surface having first and second portions. The first portion of the display surface is viewable by a vehicle occupant when the housing is in the first position and the second portion of the display is viewable by the vehicle occupant when the housing is in the second position.

According to another exemplary embodiment, a display for providing data to a vehicle occupant comprises a display surface having first and second portions and a moveable base coupled to the display surface. The moveable base is configured to display the first portion of the display in a first position and a second portion of the display in a second position.

According to another exemplary embodiment, a method of displaying data in a vehicle comprises, in a first mode, displaying first data on a first portion of a display surface while concealing a second portion of the display surface. In a second mode, the method comprises revealing the second portion of the display surface and displaying second data on the second portion of the display surface.

According to yet another exemplary embodiment, a multi-mode display for a vehicle comprises a display means for displaying data to a vehicle occupant and a moveable means for moving the display means between first and second positions such that a first portion of the display means is viewable by the vehicle occupant in the first position and the second portion of the display means is viewable by the vehicle occupant in the second position.

According to still another exemplary embodiment, a multi-mode display for a vehicle comprises a processing circuit, a moveable housing, and a display. The processing circuit is configured for operation in first and second modes. The moveable housing is moveable between a first position in the first mode and a second position in the second mode. The display is configured to receive display data from the processing circuit. In the first mode, the processing circuit is configured to provide first display data to a first portion of the display and the moveable housing is configured to reveal only a first portion of the display to a vehicle occupant. In the second mode, the processing circuit is configured to provide second display data to a second portion of the display and the moveable housing is configured to reveal first and second portions of the display to a vehicle occupant.

### BRIEF DESCRIPTION OF THE DRAWINGS

The invention will become more fully understood from the following detailed description, taken in conjunction with the accompanying drawings, wherein like reference numerals refer to like parts, and in which:

FIG. 1 is a perspective view of an instrument panel of a vehicle having a display, according to an exemplary embodiment;

FIG. 2 is a perspective view of the instrument panel of FIG. 1, wherein the display is in a first mode, according to an exemplary embodiment;

FIG. 3 is a perspective view of the instrument panel of FIG. 1, wherein the display is in a second mode, according to an exemplary embodiment;

FIGS. 4-9 are exploded views of the display of FIG. 1 illustrating exemplary systems for moving the display between first and second positions, according to an exemplary embodiment;

FIG. 10 is a perspective view of an alternative embodiment of the display of FIG. 1; and

FIGS. 11-20 are schematic views of data shown on the display of FIG. 1, according to an exemplary embodiment.

### DETAILED DESCRIPTION OF EXEMPLARY EMBODIMENTS

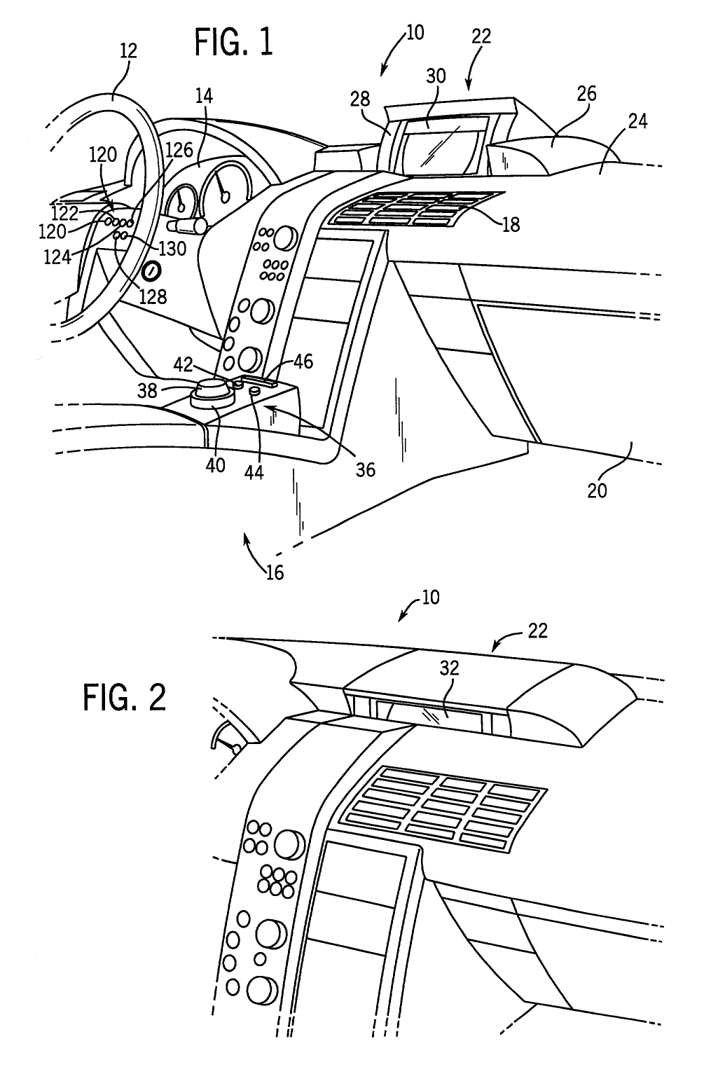

Referring first to FIG. 1, an instrument panel 10 for a vehicle is illustrated. Instrument panel 10 is illustrated in an automobile having a steering wheel 12, an instrument cluster 14, a floor console 16, thermal comfort vents 18, a glove box 20, and other vehicle accessories. A multi-position display having multiple modes 22 is coupled to instrument panel 10. Alternatively, display 22 could be used in an instrument panel or instrument cluster for other vehicles, such as, minivans, trucks, sedans, sport utility vehicles, motorcycles, aircraft, etc.

Display 22 is disposed on a top, horizontal surface 24 of instrument panel 10 and is positioned to be viewable by a vehicle occupant, such as a front seat passenger, such as the driver, and rear seat passengers. Alternatively, display 22 can be disposed in or coupled to other vehicle interior elements, such as, in the overhead console, the floor console, the steering wheel, vertical or horizontal surfaces of instrument panel 10, in interior elements in the rear of the vehicle, etc.

Display 22 includes a housing 28 or other base member movable between a plurality of positions, as will be described hereinbelow. Display 22 further includes a display surface 30 comprising a surface of a liquid crystal display (LCD) in this exemplary embodiment. Alternatively, display surface 30 may comprise other display technologies, such as, light emitting diodes (LEDs), active matrix displays, vacuum fluorescent displays, organic LEDs (OLEDs), thin film transistors (TFTs), or other display technology. Display surface 30 is coupled to housing 28 and is movable therewith. Display 22 further includes a processing circuit comprising a microprocessor, microcontroller, programmable logic, application specific integrated circuit (ASIC), input/output circuitry, and/or other analog or digital circuitry configured to receive various data and information from vehicle systems and remote systems and to format the data and information for display on display surface 30. The processing circuit is configured for operation in multiple modes, as will be described hereinbelow. The processing circuit is disposed within housing 28, but may alternatively be disposed elsewhere within the vehicle. The processing circuit further includes memory, including volatile and/or non-volatile memory and an interface circuit to communicate with display surface 30, operator input devices, a vehicle bus, and/or other vehicle systems.

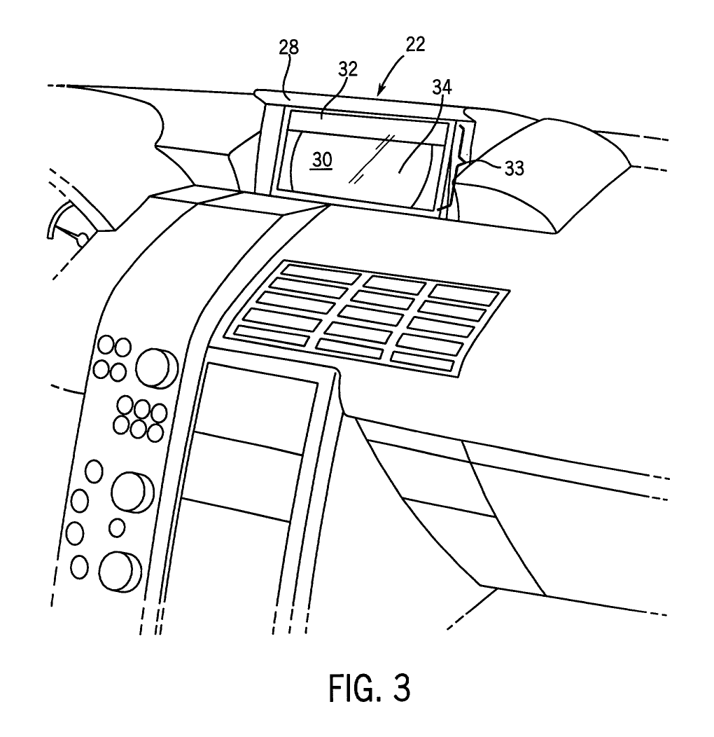

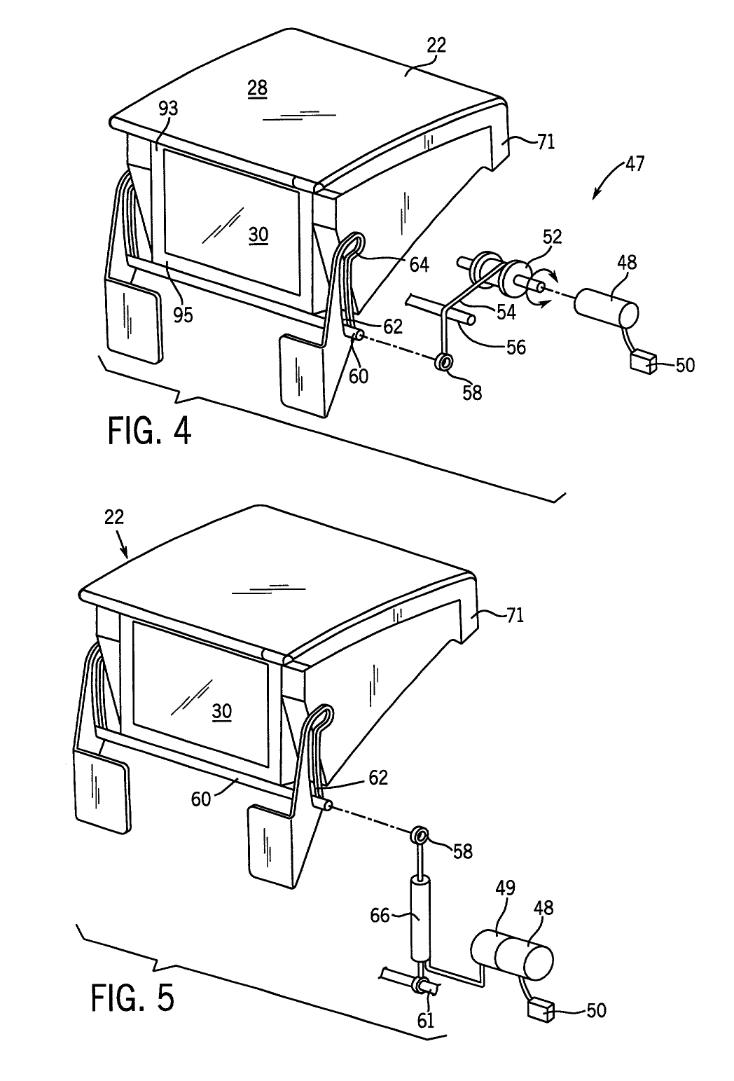

Referring now to FIGS. 2 and 3, one advantageous feature of display 22 is illustrated. In a first mode of operation (i.e., a “wink mode”), display 22 is retracted within instrument panel 10, wherein a first portion 32 of display surface 30 is viewable by a vehicle occupant (e.g., first portion 32 faces the interior of the vehicle and can be seen by a vehicle occupant during the normal course of operation of the vehicle).

Referring now to FIG. 3, display 22 is illustrated in a second mode (i.e., a “wide mode”), wherein housing 28 is in an extended position relative to instrument panel 10, wherein second portion 34 of display surface 30 is viewable by a vehicle occupant along with first portion 32. Advantageously, when in the first mode, and when housing 28 is in the first position, only a portion of the total display surface 33 is viewable by a vehicle occupant, whereby the amount of data displayed to the vehicle occupants is reduced and the amount of back lighting projected into the vehicle interior is also reduced.

As illustrated in FIG. 2, second portion 34 of display 30 is concealed by instrument panel 10 when housing 28 is in the first position. When display 22 is placed in the second mode, second portion 34 of display surface 30 is revealed and data is displayed thereon.

In this exemplary embodiment, first portion 32 has a smaller total surface area than second portion 34. Thus, first portion 32 is suitable for displaying a small amount of data which is commonly usable by vehicle occupants during typical vehicle operation. In this embodiment, first portion 32 has a height of approximately one inch. Second portion 34 is suitable for uses of display 22 requiring more data, such as, navigation maps, lists of audio selections, etc., as will be described hereinbelow. In this embodiment, first and second portions 32, 34 have a combined height of between 8 and 10 inches. In alternative embodiments, first portion 32 and second portion 34 may be approximately the same surface area, or second portion 34 may have a smaller surface area than first portion 32. Various other configurations of the various portions of display surface 30 are contemplated. In this exemplary embodiment, first portion 32 comprises a surface area of between 5 and 40 percent of the total surface area of display surface 30, and second portion 34 comprises approximately between 60 and 95 percent of the total surface area of display surface 30. A further advantageous embodiment has first portion 32 comprising approximately 10-30% of display surface 30 and second portion 34 comprising approximately 70-90% of display surface 30.

According to alternative embodiments, display 22 may have more than two positions and/or may have more than two modes, wherein display surface 30 includes more than two portions configured for use during the plurality of modes.

In this exemplary embodiment, the processing circuit of display 22 is configured to provide no displayed data on second portion 34 when second portion 34 is not viewable by a vehicle occupant. However, in alternative embodiments, second portion 34 may include display data from the processing circuit even when second portion 34 is not viewable by a vehicle occupant.

In this exemplary embodiment, as illustrated in FIG. 3, both first and second portions are viewable by vehicle occupant when display 22 is in the second mode. Alternatively, housing 28 may be configured to conceal first portion 32 of display surface 30 when in the second mode.

Referring again to FIG. 1, an operator input device 36 includes various devices for controlling display 22. Operator input device 36 is configured to receive operator commands and to provide the operator commands to the processing circuit of display 22 to change the data displayed on display 22. Input device 36 is mounted to floor console 16 in a location within a comfortable reach of the vehicle driver and the other front seat passenger. Input device 36 includes a push button/dial 38 and a second dial 40 disposed concentric with push button/dial 38 and operable independent of push button/dial 38. Input device 36 further includes a “back” button 42 and a brightness input device 44. Input device 44 can be pressed to enable selection of brightness via push button/dial 38 or second dial 40. Alternatively, input device 44 can be held down as brightness increases or decreases. Alternatively, input device 44 can pop up when pressed, allowing rotational movement to control brightness. Alternatively, input device 44 can be a slider switch to adjust brightness. Input device 36 further includes a (push-push) release button 46.

Input device 36 is mounted to floor console 16 and is movable between a first position recessed within floor console 16 and a second position extending outwardly from floor console 16 in response to operator actuation of release button 46. When in the second position, the operator presses downward on a top surface of input device 36 until input device 36 is fully recessed within floor console 16, at which point a latch within floor console 16 or input device 36 secures input device 36 to floor console 16. The latch is released by actuation of release button 46, wherein input device 36 moves to the second, extended position.

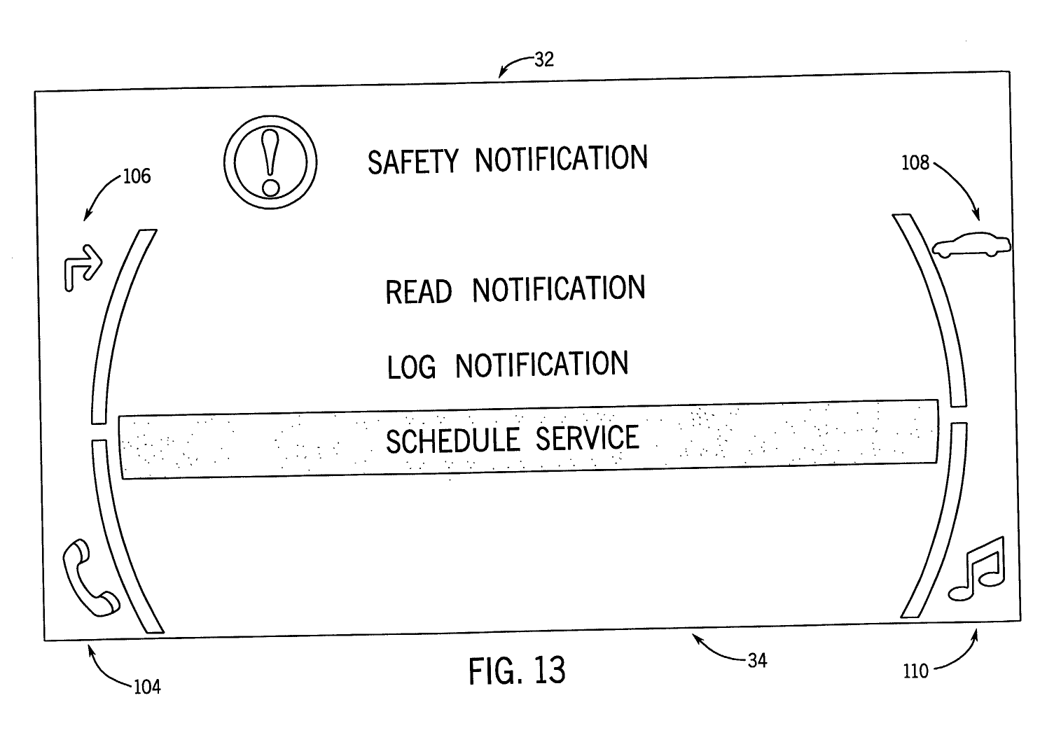

Push button/dial 38 and dial 40 are used to adjust the position of a cursor on second portion 34 of display surface 30, and push button/dial 38 is pressed to select one of the selections on display 30, which selections will be described hereinafter in exemplary form. Push button/dial 38 controls the position of a cursor on first and/or second portions 30, 34 and allows the operator to select an option on display 22 by pressing the push button. Second dial 40 controls the position of a cursor to select coarse menu selections, namely telematics, navigation, vehicle, or music (see FIG. 13). Back button 42 allows the user to return to a previously-viewed screen of information. Brightness button 44 allows the user to adjust the brightness of display surface 30. Input device 36 or one or more of push button/dial 38, dial 40, back button 42, brightness button 44, and release button 46 may be coupled to other vehicle interior elements, such as, the steering wheel, a vertical surface of the instrument panel, a horizontal surface of the instrument panel, an overhead console, etc.

In this exemplary embodiment, when release button 46 is actuated to move input device 36 from the first position to the second position, display 22 moves from the first, recessed position (FIG. 2) to the second, extended position (FIG. 3) and display 22 selects the second mode of operation. When input device 36 is moved from the second position to the first position, display 22 moves from the second, extended position to the first, recessed position and display 22 selects the first mode of operation. Thus, the mode of operation is selected based on a mode select command received from the operator via input device 36. In this embodiment, input device 36 is mounted remotely from display surface 30. One or more of the systems and methods described below in FIGS. 4-9 may be used to coordinate the movement of input device 36 and display 22. Alternatively, movement of operator input device 36 can be completely independent from movement of multi-position display 22. For example, a separate input device could be coupled to the steering wheel or to another vehicle interior element to enable movement of display 22. As another example, display 22 can be moved between first and second positions manually, wherein display 22 has a push-push actuation or a frictional engagement with instrument panel 10 or wherein display 22 has a release latch which allows for movement between the first position and the second position and further allows for fixing display 22 in any of a plurality of desired positions.

Referring now to FIG. 4, an exemplary system configured to move display 22 between various positions is shown. In this embodiment, an actuator assembly 47 includes a motor 48 driven by control signals received from a control circuit 50 (which may be part of the processing circuit of display 22 or may be independent thereof). Control circuit 50 may be operated in response to actuation of release button 46 on input device 36 or may be operated independently of input device 36. Motor 48 is a two-way stepper motor or other electric motor coupled to a spool 52 and configured to rotate spool 52 in clockwise and counter-clockwise directions. Spool 52 is rotatably coupled to instrument panel 10 and includes a cable or wire 54 disposed over a pivot 56 coupled to instrument panel 10. Wire 54 is coupled to a ring 58. Ring 58 is disposed over a rod 60 of housing 28. Rod 60 is disposed in a groove 62 and configured to slide within groove 62. Groove 62 is L-shaped at its upper end to retain display surface 30 in its extended position. A back portion 71 of display 22 may be pivotally coupled or slidably coupled to instrument panel 10.

In operation, in response to user commands, control circuit 50 drives motor 48 to rotate spool 52 clockwise. Wire 54 moves across pivot 56 to pull ring 58 in an upward direction relative to the vehicle, whereby rod 60 is pulled upward along groove 62 into L-shaped recess 64 in order to move display 22 into its extended position. In response to user commands, control circuit 50 controls motor 48 to move spool 52 in a counter-clockwise direction to allow display 22 to return to the recessed position within instrument panel 10.

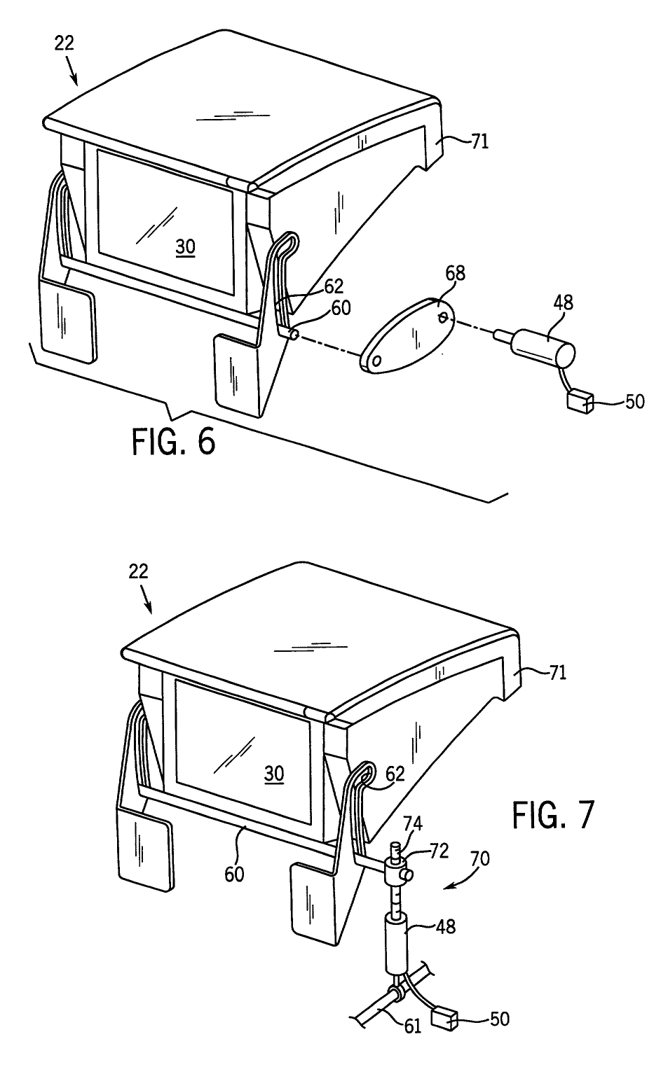

Referring now to FIG. 5, the actuator assembly is embodied as a motor 48 driving a pump 49 which drives a hydraulic piston 66 coupled to instrument panel 10, wherein ring 58 is coupled to a movable end of piston 66 and also coupled to rod 60. Operation is similar to the embodiment of FIG. 4, wherein ring 58 pushes upward on rod 60 instead of pulling upward on rod 60, as in the embodiment of FIG. 4. A pivot 61 couples a fixed end of piston 66 to instrument panel 10 rotatably to allow movement of display forward and backward relative to the vehicle.

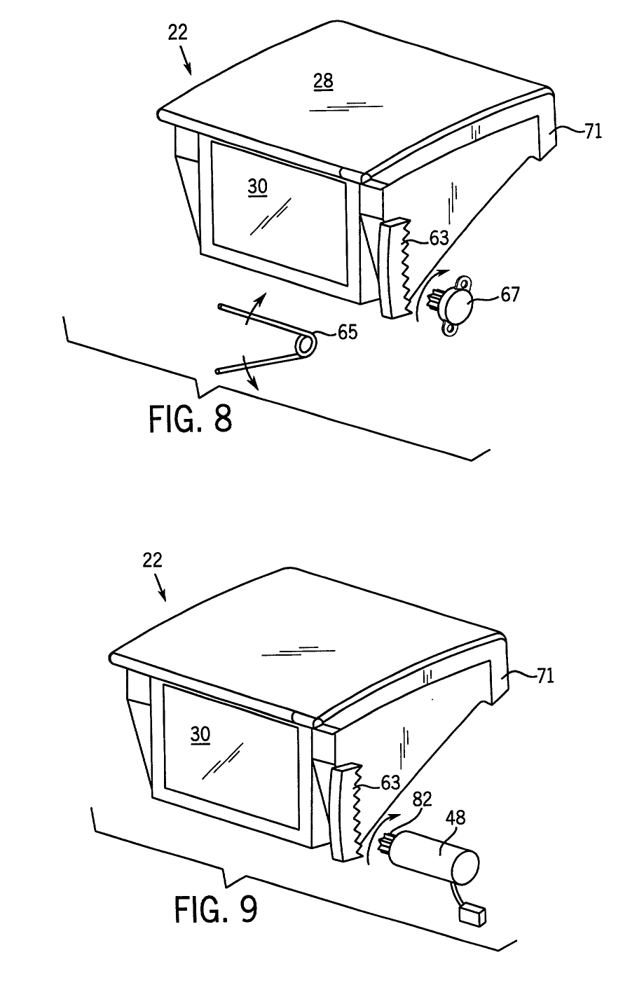

Referring to FIG. 6, an actuator is embodied as a cam 68. Motor 48 is coupled to a wide end of cam 68 and rod 60 is coupled to a narrow end of cam 68. In operation, as motor 48 rotates, cam 68 also rotates, moving rod 60 within groove 62.

Referring to FIG. 7, the actuator for display 22 is a worm gear arrangement 70 having a threaded member 72 disposed on a threaded rod 74, wherein the threads of member 72 and rod 74 are engaged. Motor 48 rotates rod 74 to impart movement in two directions to threaded member 72. Member 72 is further coupled to rod 60 and imparts a force thereon to move rod 60 within groove 62. One end of motor 48 is pivotally coupled to instrument panel 10 via pivot 61.

Referring now to FIG. 8, a fixed gear track 63 is coupled to display 22. A spring 65 imparts a force on display 22 in either an upward or downward direction. A latch (not shown) couples display 22 to instrument panel 10 in at least one position. The latch is releasable by user actuation to allow spring 65 to bias display 22 into the first or second position, and the operator pushes or pulls on display against the bias of spring 65 to return display 22 to the latched position. A damper 67 has gears in mating alignment with fixed gear track 63 and slows or dampens the movement of display 22. Thus, the embodiment of FIG. 8 allows a push-push movement of display 22.

Referring now to FIG. 9, display 22 is coupled to fixed gear track 63. Motor 48 includes a grooved element 82 in mating alignment with fixed gear track 63 and configured to rotate track 63. Track 63 may be of any suitable length, shape or thickness in order to move display 22 in any of a plurality of directions. As motor 48 rotates, track 63 imparts movement to extend and retract display 22.

FIGS. 4-9, and in the corresponding description, illustrate exemplary actuators or systems for moving display 22 between multiple positions. Other alternatives, utilizing mechanical, hydraulic, electrical, pneumatic, or other technologies, may be implemented. Such technologies may include slides, pivots, worm gears, servo motors, push/pull rods, air, rotatable members, liquid, cams, oils, etc. One or more of these options may also be utilized to move operator input device 36 between multiple positions

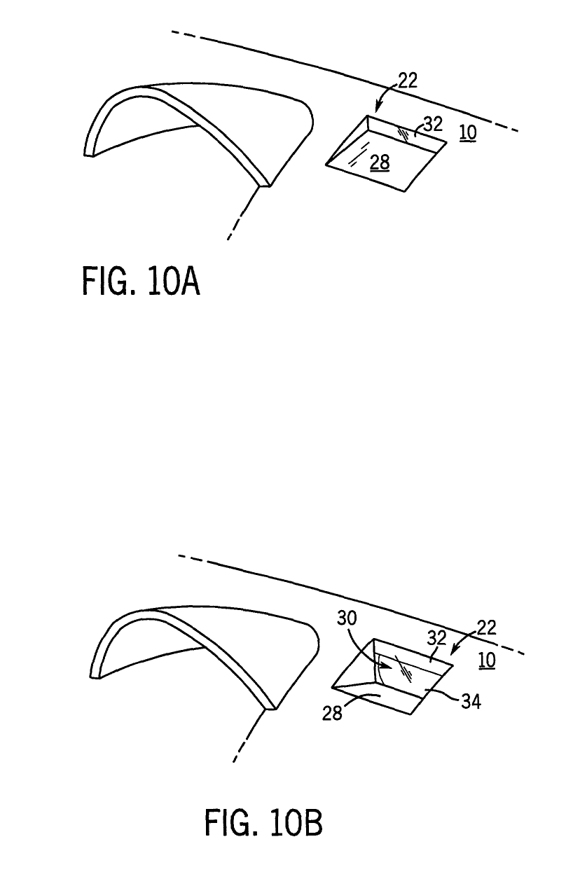

According to one advantageous feature of this exemplary embodiment, a perpendicular relationship is maintained between display surface 30 and an eye ellipse of a standard vehicle occupant. This perpendicular relationship can be maintained in any of a plurality of ways. For example, in the embodiments of FIGS. 4-9, a back portion 71 of display 22 can be configured to move slidably upward and downward with display 22 to maintain a perpendicular relationship between display surface 30 and the angle of view of an average front seat passenger. Accordingly to another alternative, display surface 30 can be configured such that top portion 93 and/or bottom portion 95 move forward or backward as display 22 moves between first and second positions so that the perpendicular relationship is maintained. According to yet another alternative embodiment, any of the actuation mechanisms disclosed in FIGS. 4-9 can be used with the alternative embodiment of display 22 illustrated in FIG. 10. As illustrated in FIG. 10, display surface 30 is recessed within instrument panel 10. In a first mode of operation, first portion 32 of display 22 is revealed and display housing 28 is coupled to display surface 30 via instrument panel 10. Housing 28 is movable using one of the actuation systems disclosed in FIGS. 4-9 between a first position, wherein first portion 32 of display surface 30 is viewable by a vehicle occupant and a second position, wherein first and second portions 32, 34 are viewable by a vehicle occupant. One advantageous aspect of this embodiment is that display surface 30 maintains a perpendicular relationship with a viewing perspective of the vehicle occupant. Further, display 22 is recessed within instrument panel 22 such that less space is occupied on the top surface of instrument panel 10.

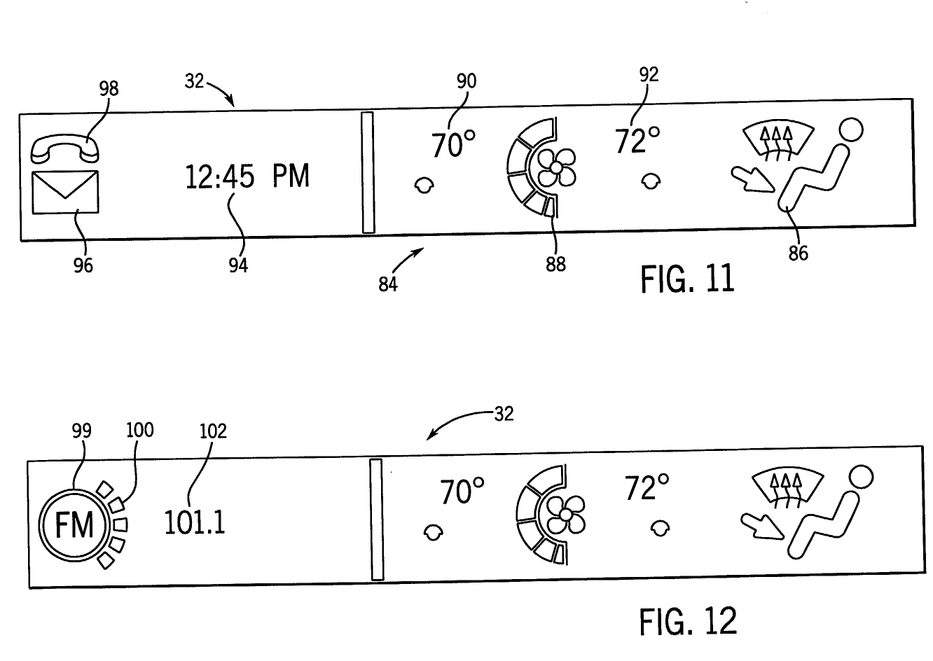

Referring now to FIGS. 11-20, exemplary data for display on first and second portions of display surface 30 will be described. Referring to FIG. 11, first portion of display surface 30 preferably provides data which is commonly used by vehicle occupants, such as, thermal comfort data 84, such as, air flow data 86, fan speed data 88, driver preferred temperature 90, passenger preferred temperature 92, etc. First portion 32 further displays a clock 94, and may also display basic telematics information, such as, whether electronic mail has arrived from a source over a wireless connection, as indicated by E-mail icon 96, and whether a voice message has arrived via voice mail icon 98.

Referring to FIG. 12, the audio source, such as, FM, AM, XM, CD, MP3, or other source is indicated by an audio source icon 99. A signal strength indicator 100 may also be provided along with a frequency indication 102. First portion 32 may also display information from a radio data system (RDS) or other digital data format, such as, the radio station, the type of music transmitted by the radio source, the title of the song and author of the song, concert tour information, etc. CD information, such as track and time remaining, may be displayed in first portion 32.

In other embodiments, first portion 32 of display surface 30 may also provide turn-by-turn navigation information (e.g., “New York Avenue, 2.5 miles, turn right ahead” and a turn arrow icon). Further still, first portion 32 may provide a warning display of certain mission critical data, such as, low fuel, low tire pressure, etc. In other alternative embodiments, other vehicle data, including other entertainment or information data, vehicle status data, engine data, or other data may be provided in first portion 32.

Referring now to FIG. 13, second portion 34 of display surface 30 is configured to provide data for the subjects or topics of telematics, as indicated by telematics icon 104, navigation as indicated by navigation icon 106, vehicle as indicated by vehicle icon 108, and music as indicated by music icon 110. In the display of FIG. 13, a safety notification has just been received wirelessly from a dealership or other remote source. The “safety notification” message is provided in first portion 32 and options are provided in second portion 34 to “read notification”, “log notification”, or “schedule service”. For example, information regarding recalls, a change in maintenance schedule, and other notifications can be read and saved. If necessary, service can be scheduled using the “schedule service” feature.

Second portion 34 can also be utilized to display the date and day of the week, and can also be utilized to display appointment information stored by the processing circuit of display 22. Further, digital photographs can be displayed in second portion 34. Further, a real-time display of a video camera mounted inside or outside of the vehicle can be provided in second portion 34 so that the driver or other vehicle occupant can monitor activities in and around the vehicle. Any of the data displayed on first or second portions of display surface 30 can be displayed in response to either operator selection (i.e., manually) or based upon a trigger value or trigger condition of the data to be displayed (i.e., automatically).

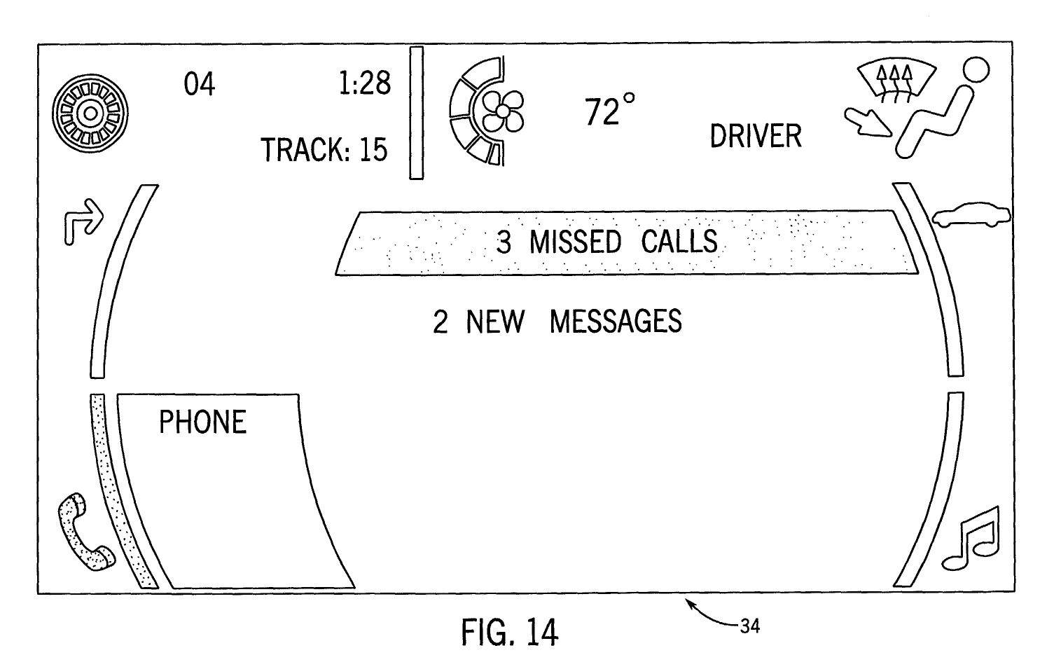

Referring to FIG. 14, second portion 34 can display information regarding phone messages received by a wireless phone system integrated within the vehicle. FIG. 14 illustrates that three calls were missed and two new messages were left. The driver can view information regarding the missed calls, such as caller identification, and can review messages which have been converted to text or may be recorded in audio and played back by a speaker coupled to display 22 or transmitted wirelessly to a near-by wireless phone within the vehicle.

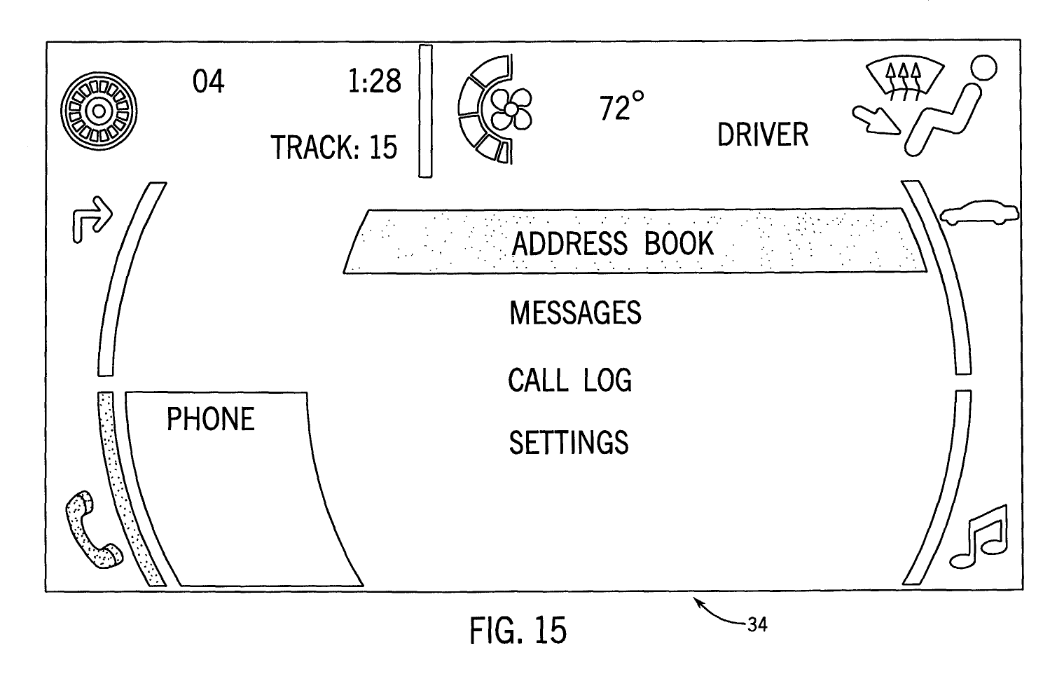

Referring to FIG. 15, other phone options include reviewing an address book, reviewing messages, reviewing a call log, adjusting other settings, etc. When the address book is selected using push button/dial 38, a list of addresses and phone numbers is displayed in second portion 34. In first portion 32, the letters A-Z are displayed so that the operator may jump to a portion of the address book including names with the specified letter. Optionally, display 22 may include an input/output port using either wired or wireless technology to synchronize the address book or other data on display 22 with a handheld personal digital assistant, a wireless phone, a laptop, or another portable system. A user selects a phone number from the address book and presses push button/dial 38 to dial a phone integral with instrument panel 10 or to control a phone wirelessly which is not integral with instrument panel 10. Display 22 then monitors the call time and displays the call time to the user so the user may track how many minutes the call has lasted.

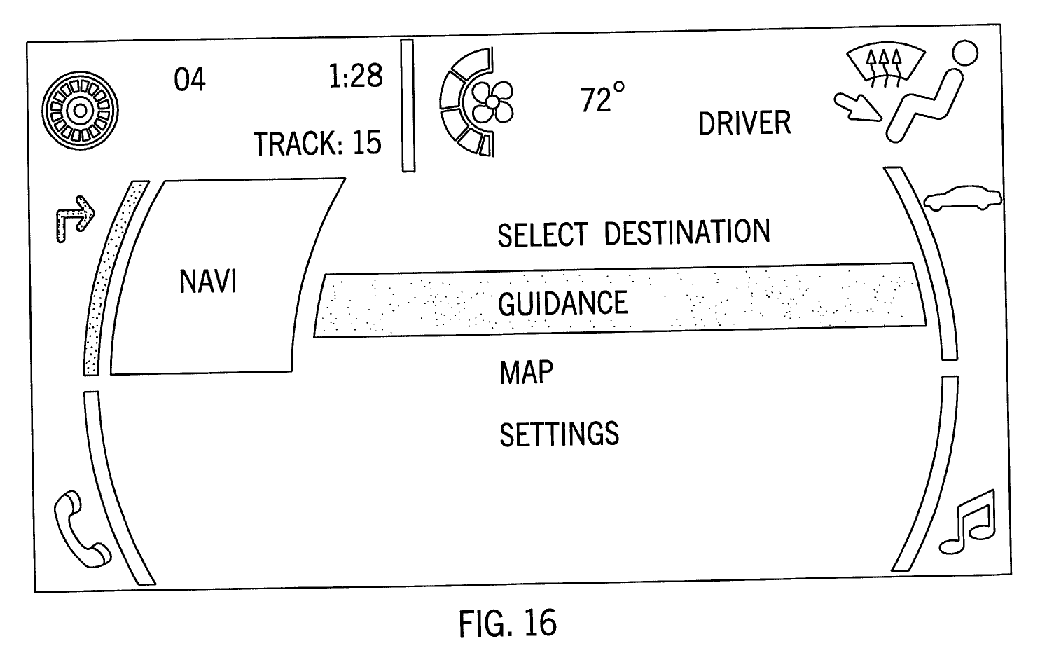

Referring now to FIG. 16, a navigation menu is illustrated, wherein the user may choose “select destination”, “guidance”, “map”, and “settings”. By using a global positioning system (GPS) receiver and navigation system and a geographic information system (GIS) database, the operator may select destinations, obtain turn-by-turn navigation with the “guidance” option, view a map, and adjust other settings of the navigation system. Display surface 30 can provide a map in second portion 34 or both first and second portions 32, 34. The map may be computer generated or may include a satellite photo downloaded from a satellite photo source, such as a web site on the Internet. The vehicle's current position and destination can be traced on the satellite photo, including the desired path for traveling from the current position to the destination. Turn-by-turn navigation information can also be provided in a portion of the map display. Alternatively, turn-by-turn navigation information can be provided alone in second portion 34.

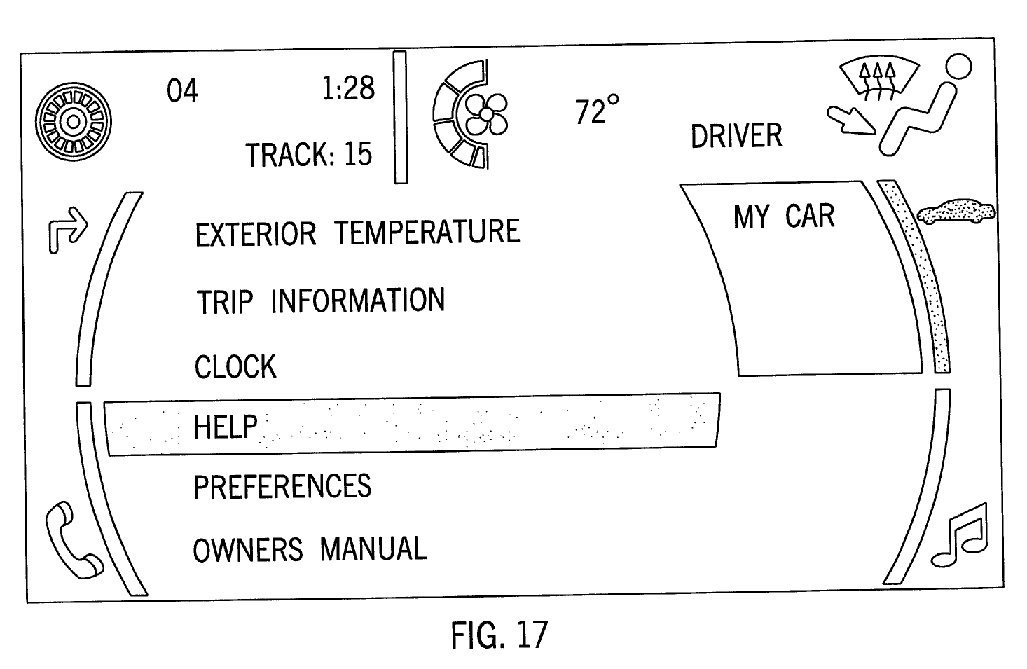

Referring now to FIG. 17, the “my car” options are illustrated, including exterior temperature, trip information, clock, help, preferences and owner's manual. Selecting the “owner's manual” option allows the user to view options regarding basic operation, instruments and controls, air conditioning, audio, starting and driving, maintenance schedule, etc. The owner's manual may include images of the vehicle to assist the user in identifying parts of the vehicle referenced in the owner's manual.

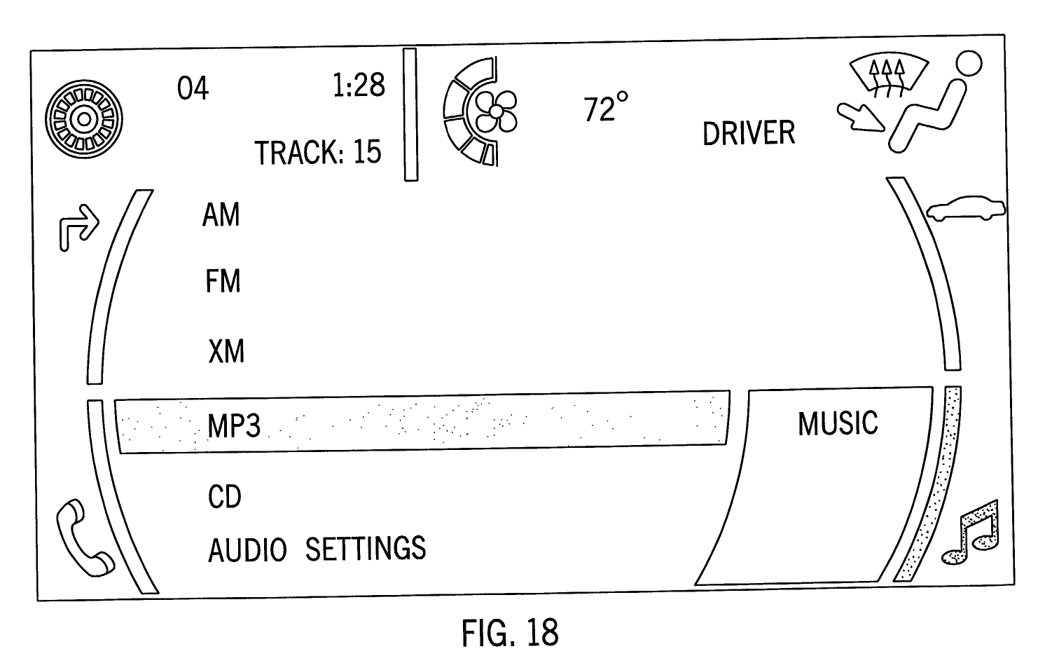

Referring to FIG. 18, audio options are illustrated, including audio sources AM, FM, XM, MP3, CD, and other audio settings which are available.

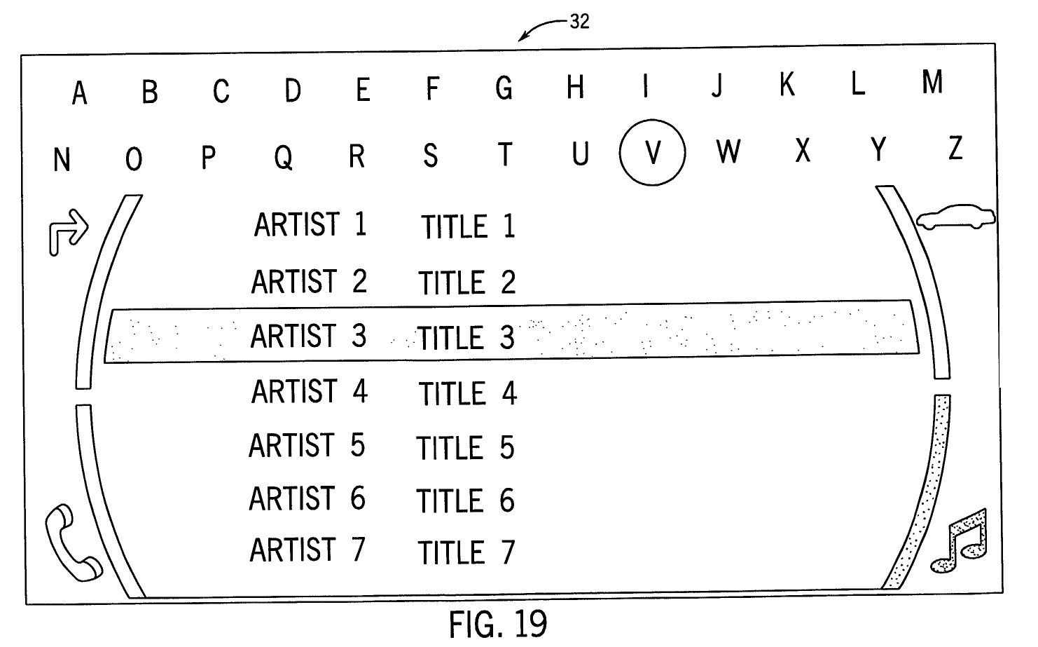

Referring to FIG. 19, MP3 songs are stored in display 22 and are accessible using an alphabetical listing. The letters A-Z are displayed in first portion 32 to allow the user to jump to a particular portion of the listing of MP3 songs. Upon selection of a song, a photo of the album cover, the date, the album title, the label, and the genre of music can be displayed.

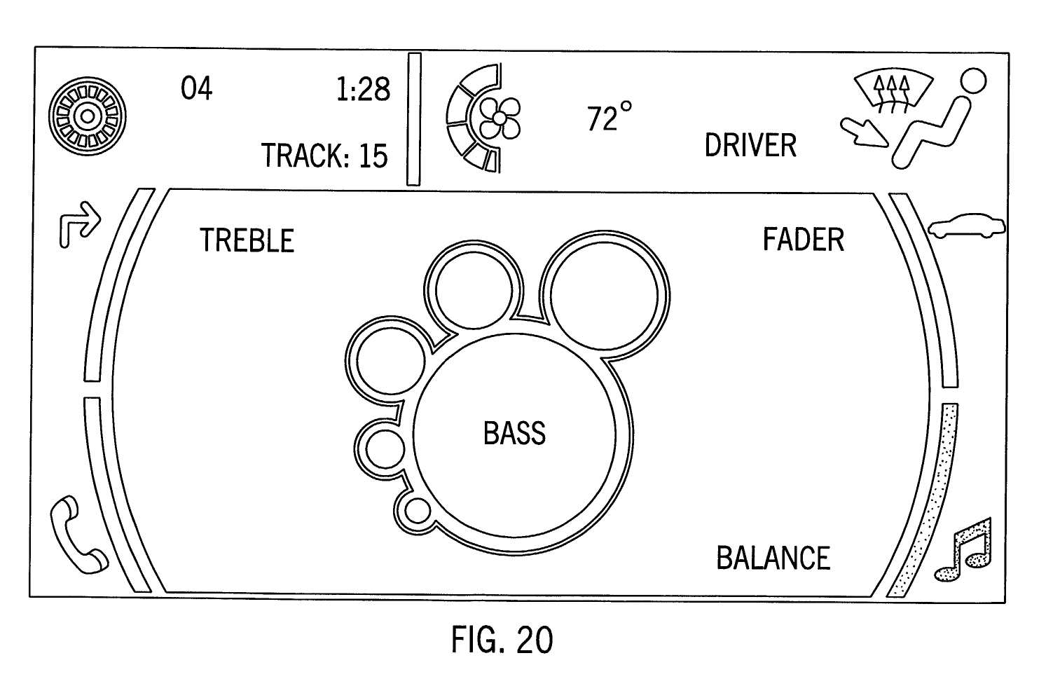

Upon selecting audio settings (FIG. 18), various audio settings can be adjusted, including treble, bass, fader and balance as indicated in FIG. 20.

First portion 32 can be configured to display mission critical data, such as, oil, engine temperature, battery, tire pressure, fuel level, etc., and second portion 34 can be configured to display non-mission critical data, such as, turn-by-turn navigation, automated cruise control (i.e., cruise control based upon the distance between a vehicle in front of the vehicle), parking aide assistant (i.e., using near obstacle detection systems to indicate to the driver the number of feet from a near-by obstacle to assist in parking), etc. Non-mission critical data can also include navigation data and telematics data (e.g., data relating to wireless telephone, Internet, e-mail, remote control of vehicle options, etc.).

Referring again to FIG. 1, in this exemplary embodiment, steering wheel 12 includes a plurality of operator input devices 120 coupled to the processing circuit of display 22. Button 122 is a telephone control button configured to answer and hang up a telephone. Button 122 is a mute button configured to mute the audio provided by display 22. Button 124 is an address book button configured to display the address book on display surface 30. Button 126 is an “operator” button configured to send a wireless signal to a remote service station, wherein driver assistance can be obtained from the service station. Button 128 is a turn-by-turn navigation button configured to select navigation in a turn-by-turn mode to be displayed on display 22. Button 130 is an instrument cluster toggle button for selecting one of a plurality of mission critical or non-mission critical data to be displayed on a reconfigurable display on instrument cluster 14.

While the exemplary embodiments illustrated in the FIGS. and described above are presently preferred, it should be understood that these embodiments are offered by way of example only. For example, various other adjustable housings may be used to reveal one or more portions of display surface 30 and to conceal one or more portions of display surface 30 in a plurality of different modes. Also, display 22 can be mounted in various locations within the interior of the vehicle. Accordingly, the present invention is not limited to a particular embodiment, but extends to various modifications that nevertheless fall within the scope of the appended claims.

What is claimed is:

1. A multi-position display for a vehicle, comprising:
a housing movable between first and second positions; and
a display surface coupled to the housing having first and second portions, wherein the first portion of the display surface is viewable by a vehicle occupant when the housing is in the first position and the second portion of the display is viewable by the vehicle occupant when the housing is in the second position.

2. The multi-position display of claim 1, wherein the first and second portions of the display are viewable by the vehicle occupant when the housing is in the second position.

3. The multi-position display of claim 2, wherein the housing is moveably coupled to an instrument panel of an automobile.

4. The multi-position display of claim 3, wherein the second portion of the display is concealed by the instrument panel when the housing is in the first position.

5. The multi-position display of claim 1, wherein the first portion of the display is configured to display thermal comfort data.

6. The multi-position display of claim 1, wherein the second portion of the display is configured to display navigation data.

7. The multi-position display of claim 1, wherein the second portion of the display is larger than the first portion of the display.

8. The multi-position display of claim 1, further comprising:
a processing circuit configured to provide display data to the display surface;
an operator input device configured to receive operator commands and to provide the operator commands to the processing circuit to change the display data.

9. The multi-position display of claim 8, wherein the operator input device is mounted on a vehicle interior element remote from the display surface, wherein the operator input device is configured to operate an actuator coupled to the housing and configured to move the housing between the first and second positions in response to operator commands.

10. The multi-position display of claim 9, wherein the operator input device is coupled to an input device housing, wherein the input device housing is moveable between a first position recessed within the vehicle interior element and a second position extending from the vehicle interior element in response to operator commands.

11. The multi-position display of claim 9, wherein the vehicle interior element is selected from the group consisting of a steering wheel, an instrument panel vertical surface, an instrument panel horizontal surface, and a floor console.

12. The multi-position display of claim 1, wherein the first portion of the display surface comprises between approximately 5 to 40 percent of the total surface area of the display surface and the second portion of the display surface comprises between approximately 60 and 95 percent of the total surface area of the display surface.

13. A display for providing data to a vehicle occupant, comprising a display surface having first and second portions and a moveable base coupled to the display surface configured to display the first portion of the display in a first position and a second portion of the display in a second position.

14. The display of claim 13, wherein the display surface is pivotally coupled to the moveable base at a coupling member, wherein the coupling member is configured to maintain a perpendicular relationship between the display surface and an eye ellipse of a vehicle occupant.

15. The display of claim 13, wherein the second portion of the display is concealed within a vehicle interior element when the moveable base is in the first position.

16. The display of claim 13, wherein the display surface includes a liquid crystal display.

17. The display of claim 13, further comprising an operator input device coupled to a vehicle interior element configured to enable movement of the moveable base between the first and second position.

18. The display of claim 13, wherein the operator input device is coupled to an input device housing which is retractable within a vehicle interior element.

19. The display of claim 13, wherein the moveable base is pivotally coupled to an instrument panel of the vehicle.

20. The display of claim 13, wherein the display is configured to display mission critical data in the first portion of the display and non-mission critical data in the second portion of the data.

21. The display of claim 20, wherein the non-mission critical data includes navigation data and telematics data.

22. A method of displaying data in a vehicle, comprising:
in a first mode, displaying first data on a first portion of a display surface while concealing a second portion of the display surface; and
in a second mode, revealing the second portion of the display surface and displaying second data on the second portion of the display surface.

23. The method of displaying data of claim 22, wherein the first data includes thermal comfort data and the second data includes navigation data.

24. The method of displaying data of claim 22, further comprising:
receiving a mode select command from an operator input device mounted remotely from the display surface; and
selecting one of the first and second mode based on the mode select command.

25. A multi-mode display for a vehicle, comprising:
display means for displaying data to a vehicle occupant; and
moveable means for moving the display means between first and second positions such that a first portion of the display means is viewable by the vehicle occupant in the first position and the second portion of the display means is viewable by the vehicle occupant in the second position.

26. The multi-mode display of claim 25, wherein the display means includes a liquid crystal display.

27. The multi-mode display of claim 25, wherein the moveable means includes an electric motor.

28. The multi-mode display of claim 25, wherein the moveable means includes a mechanical linkage to an operator input device mounted remotely from the display means.

29. The multi-mode display of claim 25, wherein, in the first position, only the first portion of the display is viewable by the vehicle occupant and, in the second position, both the first and second portions of the display are viewable by the vehicle occupant.

30. A multi-mode display for a vehicle, comprising:
a processing circuit configured for operation in first and second modes;
a moveable housing moveable between a first position in the first mode and a second position in the second mode; and
a display configured to receive display data from the processing circuit, wherein, in the first mode, the processing circuit is configured to provide first display data to a first portion of the display and the moveable housing is configured to reveal only a first portion of the display to a vehicle occupant and, in a second mode, the processing circuit is configured to provide second display data to a second portion of the display and the moveable housing is configured to reveal first and second portions of the display to a vehicle occupant.

31. The multi-mode display of claim 30, wherein the first display data includes thermal comfort data and the second display data includes navigation data.

32. The multi-mode display of claim 30, wherein the second display data includes a list of sources of audio signals and the first display data includes data indicating the selected source of audio signals.

33. The multi-mode display of claim 30, wherein the moveable housing is coupled to an instrument panel of the vehicle in view of a front seat passenger.
